(19) United States
(12) Patent Application Publication
(10) Pub. No.: US 2026/0220762 A1
(43) Pub. Date: Jul. 30, 2026

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: FUMIAKI TAKAHASHI, Kanagawa (JP)

(21) Appl. No.: 19/446,575

(22) Filed: Jan. 12, 2026

(30) Foreign Application Priority Data
Jan. 27, 2025 (JP) 2025-011656

(51) Int. Cl. G06T 7/00; H04N 23/55; H04N 23/73; H04N 23/74

(52) U.S. Cl. CPC G06T 7/0004; H04N 23/55; H04N 23/73; H04N 23/74; G06T 2207/30112

(57) ABSTRACT

A processing apparatus includes a setting unit that sets an ID unique to article that is an image capturing target object, a storage unit that stores a feature of article for the ID, a first acquisition unit that acquires a feature of the article corresponding to the ID from the storage unit, a second acquisition unit that acquires an image in which the article is imaged, and an evaluation unit that evaluates whether a feature of the article is represented in the image.

### BACKGROUND

### Field of the Technology

The aspect of the embodiment relates to an information processing apparatus for improving image capturing quality of articles.

### Description of the Related Art

Currently, the reuse industry that sells secondhand brand bags and the like is booming due to global inflation, weak Japanese Yen, motivation as SDGs, a decrease in psychological barriers for purchasing reuse items, and the like.

In secondhand goods trade, sales on the Internet have increased compared to physical stores, and in the Internet sales, the quality of a merchandise photograph is a particularly important item for improving the close rate.

On the other hand, images need to be captured for secondhand goods one by one, the number of man-hours required for image capturing increases, and the cost for improving the image capturing quality may become an issue.

Image capturing is performed mainly by a person in charge who is unfamiliar with photography in accordance with a manual, in a merchandise image capturing booth or the like installed at a site where the merchandise is stocked. However, even if the image capturing is performed in accordance with the manual, there is an issue that it is difficult to image each item of merchandise with high quality.

As a prior art for improving image capturing quality, Japanese Patent Laid-Open No. 2016-119052 discloses a technique for re-imaging a barcode by changing illumination and image capturing parameters in a case of failing in barcode recognition.

Japanese Patent Laid-Open No. 2021-56992 discloses a technique for displaying a message instructing re-imaging in a case where the recognition rate of merchandise is a predetermined value or less.

However, the technique disclosed in Japanese Patent Laid-Open No. 2016-119052 is a technique specialized for clearly image capturing the black-and-white pattern of the barcode, and does not contribute to improvement in image capturing quality for improving the close rate of a brand-name bag or the like.

The technique disclosed in Japanese Patent Laid-Open No. 2021-56992 only discloses instructing re-imaging based on the recognition rate of merchandise, and does not have a function of determining image capturing quality of the merchandise.

### SUMMARY

According to an aspect of the embodiments, there is provided a processing apparatus comprising: at least one processor and at least one memory storing instructions to cause the at least one processor to function as: a setting unit that sets an ID unique to article that is an image capturing target object; a storage unit that stores a feature of article for the ID; a first acquisition unit that acquires a feature of the article corresponding to the ID from the storage unit; a second acquisition unit that acquires an image in which the article is imaged; and an evaluation unit that evaluates whether a feature of the article is represented in the image.

Features of the disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the disclosure, and together with the description, serve to explain the principles of the embodiments.

FIG. 1 is a view illustrating an appearance of a first embodiment of a reuse merchandise image capturing system using an information processing apparatus of the disclosure.

FIG. 2 is a basic configuration diagram of the reuse merchandise image capturing system.

FIG. 3 is a view illustrating a merchandise information table stored in a merchandise feature storage unit.

FIG. 4 is a flowchart showing processing of reuse merchandise image capturing and merchandise feature evaluation.

FIG. 5 is a view describing merchandise feature evaluation processing by a merchandise feature evaluation unit.

FIG. 6 is a view illustrating a configuration of a reuse merchandise image capturing system in a second embodiment.

FIG. 7 is a flowchart showing reuse merchandise image capturing processing in the second embodiment.

FIG. 8 is a view illustrating a merchandise information table in a third embodiment.

FIG. 9 is a work flowchart of information recording processing into the merchandise information storage unit.

FIG. 10 is a view illustrating a configuration of a reuse merchandise image capturing system in the third embodiment.

FIG. 11 is a flowchart showing reuse merchandise image capturing processing in the third embodiment.

FIG. 12 is a flowchart showing image capturing condition change processing in the third embodiment.

FIG. 13 is an external view of a reuse merchandise image capturing system in a fourth embodiment.

FIG. 14 is a view illustrating a configuration of the reuse merchandise image capturing system in the fourth embodiment.

FIG. 15 is a flowchart showing image capturing condition change processing in the fourth embodiment.

FIG. 16 is a view illustrating a configuration of a reuse merchandise image capturing system in a fifth embodiment.

FIG. 17 is a view illustrating display for instructing a user to mount a mounting member.

FIG. 18 is a flowchart showing image capturing condition change processing in the fifth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted. Furthermore, the disclosure will be described with reference to an image capturing system for capturing a merchandise as a target, but the target is not limited to the merchandise, and the target may be a simple article not for commercial use.

### First Embodiment

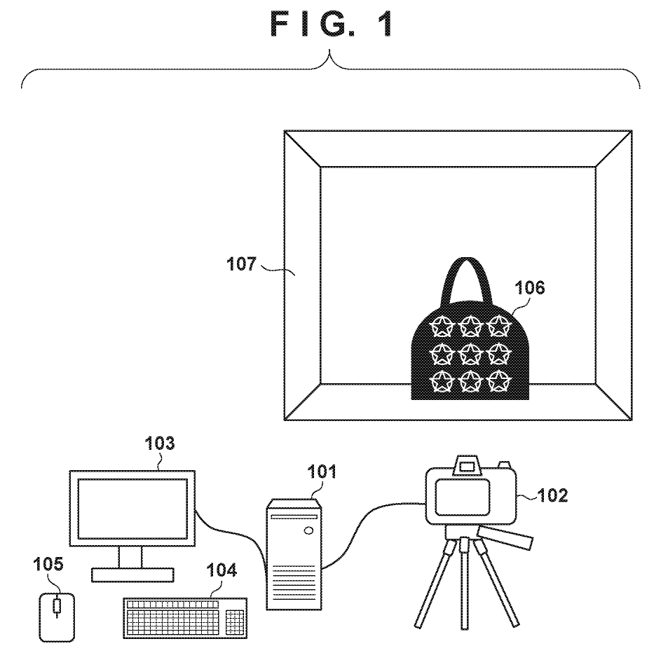

FIG. 1 is a view illustrating an appearance of the first embodiment of a reuse merchandise image capturing system using an information processing apparatus of the disclosure.

An information processing apparatus 101 is constituted by a personal computer or a server computer, and includes a GPGPU (General-Purpose computing on Graphics Processing Units) for performing deep learning inference at high speed.

An image capturing apparatus 102 includes a digital camera and includes a lens that can image at an angle of view corresponding to an image capturing distance to merchandise (article) that is a target in order to perform higher quality merchandise image capturing. The image capturing apparatus 102 can transmit and receive commands and data to and from the information processing apparatus 101 in a wired or wireless manner. Then, it is possible to perform image capturing in accordance with a command from the information processing apparatus 101, change an image capturing condition, and transfer a captured image to the information processing apparatus 101.

A display 103 displays a user interface to be used when a person in charge of image capturing confirms an captured image or operates a keyboard 104 or a mouse 105 to perform input to the information processing apparatus 101.

A reuse product 106 is an image capturing target object, and a brand bag is taken as an example in the embodiment. However, the reuse merchandise is not limited to this, and may be any merchandise that is generally handled as reuse merchandise such as watches, clothes, and wallets. An image capturing booth 107 is a booth used for reuse merchandise image capturing.

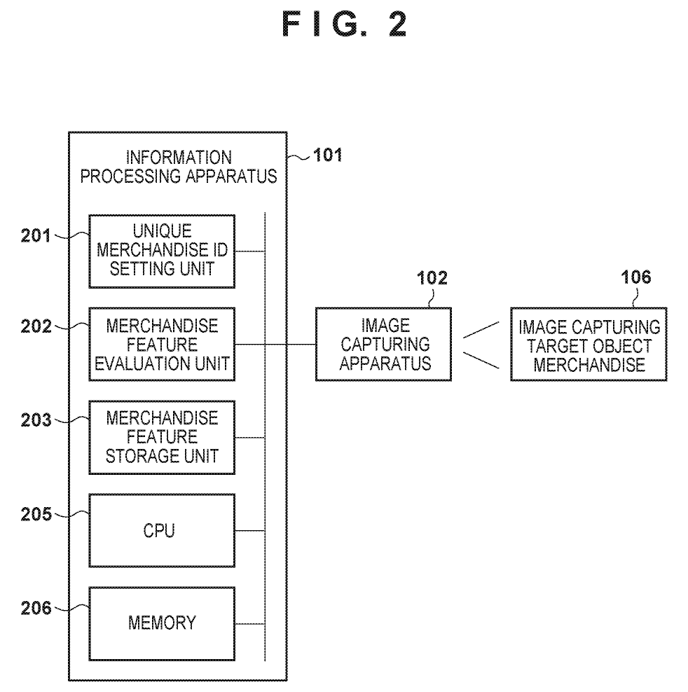

FIG. 2 is a view illustrating a basic configuration of the information processing apparatus 101.

In the embodiment, the information processing apparatus 101 includes a personal computer (hereinafter PC), for example. Then, each functional unit of the information processing apparatus 101 is implemented by reading, into a central processing unit (CPU) 205, and executing a program stored in a memory 206.

A unique merchandise ID setting unit 201 sets a unique merchandise ID (unique ID) unique to merchandise to be imaged. In the embodiment, the unique merchandise ID is set by the user inputting it on the keyboard 104. However, the setting of unique merchandise ID is not limited to this, and the unique merchandise ID may be automatically set by analyzing a video of image capturing target object merchandise by AI, or may be automatically set by receiving data from a reuse merchandise management system not illustrated. This can save time and effort of user input.

A merchandise feature evaluation unit 202 reads information regarding a merchandise feature from a merchandise feature storage unit 203, and evaluates whether or not the merchandise feature is represented in an captured image.

Note that each of the functional units of the unique merchandise ID setting unit 201, the merchandise feature evaluation unit 202, and the merchandise feature storage unit 203 may be configured by an individual circuit, or may be implemented by the CPU 205 executing a program stored in the memory 206.

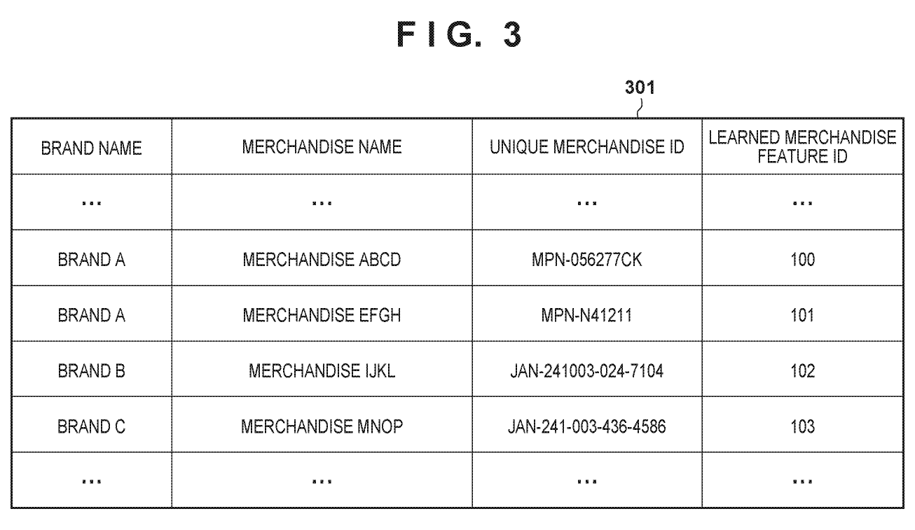

FIG. 3 is a view illustrating a merchandise information table 301 stored in the merchandise feature storage unit 203.

As illustrated in FIG. 3, the merchandise feature storage unit 203 records, together with a brand name, a merchandise name, and a unique merchandise ID of merchandise handled by a dealer as reuse merchandise, an ID of a learned merchandise feature that should be represented in a photograph of the corresponding unique merchandise ID.

Note that in the embodiment, unique merchandise ID systems include a plurality of systems such as MPN and JAN as those that can uniquely specify merchandise in the world. Therefore, as illustrated in FIG. 3, the unique merchandise ID is specified in a form in which the name of the system and the ID in each system are linked together. However, the specification method is not limited to this, and may be another specification method that can uniquely specify merchandise such as a character string combining a brand name, a merchandise name, and a color.

In the embodiment, an object detection technique which is one of deep learning is used. Specifically, a characteristic portion of an image of each item of merchandise is surrounded by a frame in advance, and supervisory data given a class ID is created for the frame. Then, learning is perform using the merchandise feature as supervisory data with the unique merchandise ID as input, and the class ID used as the supervisory data is stored as a learned merchandise feature ID.

Note that in the embodiment, You Only Look Once (YOLO), which is currently used in general, is used as a network model of object detection, but the network model is not limited to this, and a model with high inference accuracy may be appropriately used at the time point of design.

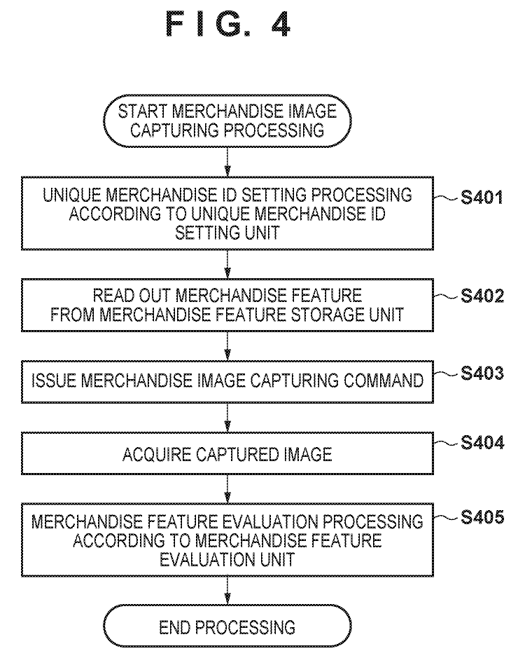

FIG. 4 is a flowchart showing processing of reuse merchandise image capturing and merchandise feature evaluation by the information processing apparatus 101 illustrated in FIG. 2. Note that S indicates a step number.

When merchandise image capturing processing is started, in S401, the CPU 205 performs unique merchandise ID setting processing using the unique merchandise ID setting unit 201. As described above, in the embodiment, the user inputs a unique merchandise ID of the merchandise 106, which is currently an image capturing target object, using the keyboard 104. In description of the present flow, merchandise EFGH illustrated in a table 301 of FIG. 3 is imaged, and the user inputs a unique merchandise ID = MPN-N41211.

In S402, with reference to storage content of the merchandise feature storage unit 203, the CPU 205 reads the learned merchandise feature ID corresponding to the unique merchandise ID = MPN-N41211 as illustrated in the table 301 of FIG. 3. FIG. 3 indicates that the read learned merchandise feature ID = 101.

In S403, the CPU 205 issues an image capturing execution command to the image capturing apparatus 102, and the image capturing apparatus 102 images the image capturing target object merchandise 106.

In S404, the CPU 205 receives a captured merchandise image from the image capturing apparatus 102.

In S405, the CPU 205 performs merchandise feature evaluation processing by the merchandise feature evaluation unit 202.

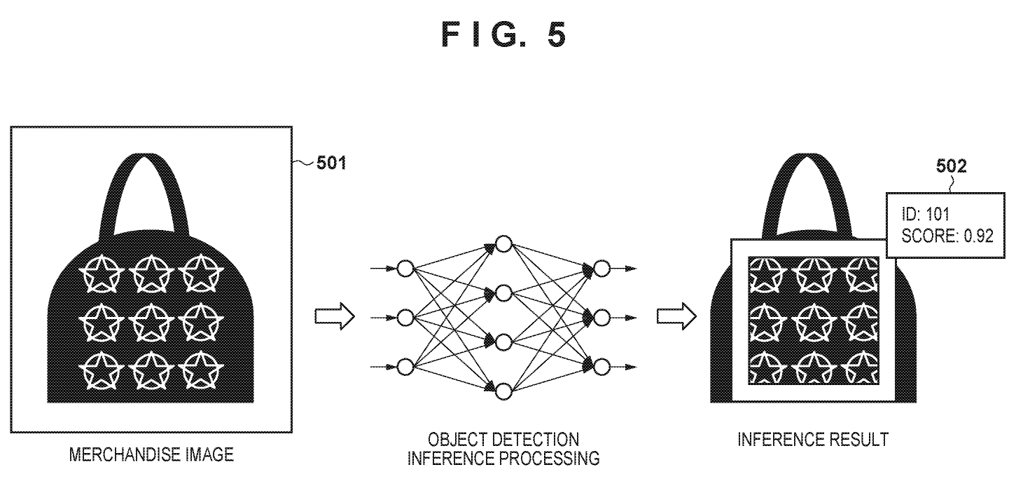

FIG. 5 is a view describing merchandise feature evaluation processing by the merchandise feature evaluation unit 202.

The merchandise feature evaluation unit 202 executes inference by object detection on a captured merchandise image 501 and acquires an inference result 502.

As the inference result 502 with the merchandise captured image 501 as input, it is possible to obtain an area in which a feature corresponding to the learned merchandise feature ID exists in the captured merchandise image 501 and a score (evaluation result) indicating the probability of the feature.

FIG. 5 illustrates that the merchandise feature indicated by the learned merchandise feature ID = 101 is detected from the captured merchandise image 501 with a score of 0.92. In the embodiment, whether or not a merchandise feature is detected is evaluated with a score of 0.8 or more as a threshold. However, the threshold is not limited to this, and in a case where it is desired to more strictly secure the quality of the image, a larger value is set as a degree to which a feature region is represented in the photograph. Conversely, in a case where it is sufficient that a certain level of quality can be secured due to limitation of an image capturing time or the like, a smaller value may be set, and a reasonable value may be set in accordance with convenience in business execution.

In FIG. 5, since the merchandise feature matching the learned merchandise feature ID = 101 is obtained with the score 0.92 from the captured merchandise image 501, the merchandise feature evaluation unit 202 evaluates that a sufficient merchandise feature is represented in the captured merchandise image 501, and ends the processing.

In a case where the corresponding learned merchandise feature ID is not detected with a score of 0.8 or more as an inference result, output of an instruction to display a warning or the like prompting re-imaging on the display 103 enables the user to recognize the necessity of re-imaging. In this case, by performing re-imaging after changing image capturing conditions or the like, it is possible to obtain a high-quality merchandise captured image without completing image capturing while the merchandise feature remains unclear. Alternatively, a warning or the like prompting changing the setting of the image capturing apparatus 102 and then re-imaging may be displayed on the display 103.

In the above description, re-imaging is to be performed in a case that the detection score of the merchandise feature is lower than a predetermined score. However, the user may be notified of an evaluation result (score) of the degree to which the merchandise feature is represented in the captured image or a result as to whether or not the score exceeds a predetermined value, by displaying the evaluation result on the display 103 or the like.

### Second Embodiment

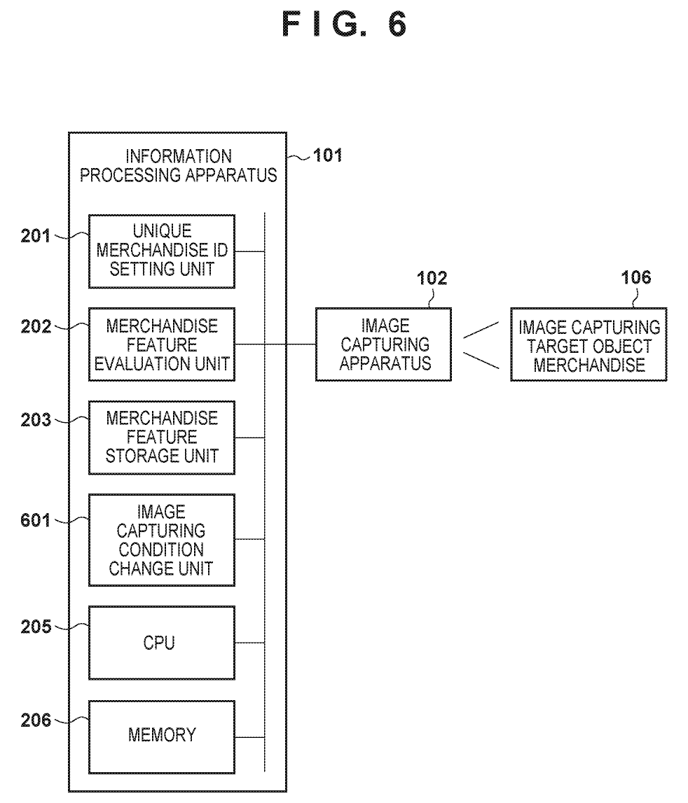

FIG. 6 is a view illustrating the configuration of the second embodiment of the reuse merchandise image capturing system.

As illustrated in FIG. 6, the information processing apparatus 101 of the second embodiment includes an image capturing condition change unit 601. Then, in a case where the evaluation value by the merchandise feature evaluation unit 202 is lower than a predetermined value, the image capturing condition change unit 601 issues an image capturing condition change instruction to the image capturing apparatus 102 in order to perform higher quality image capturing. After the image capturing condition is changed, the image capturing apparatus 102 performs re-imaging of the target merchandise. Note that other configurations 201 to 206 are similar to those of the first embodiment.

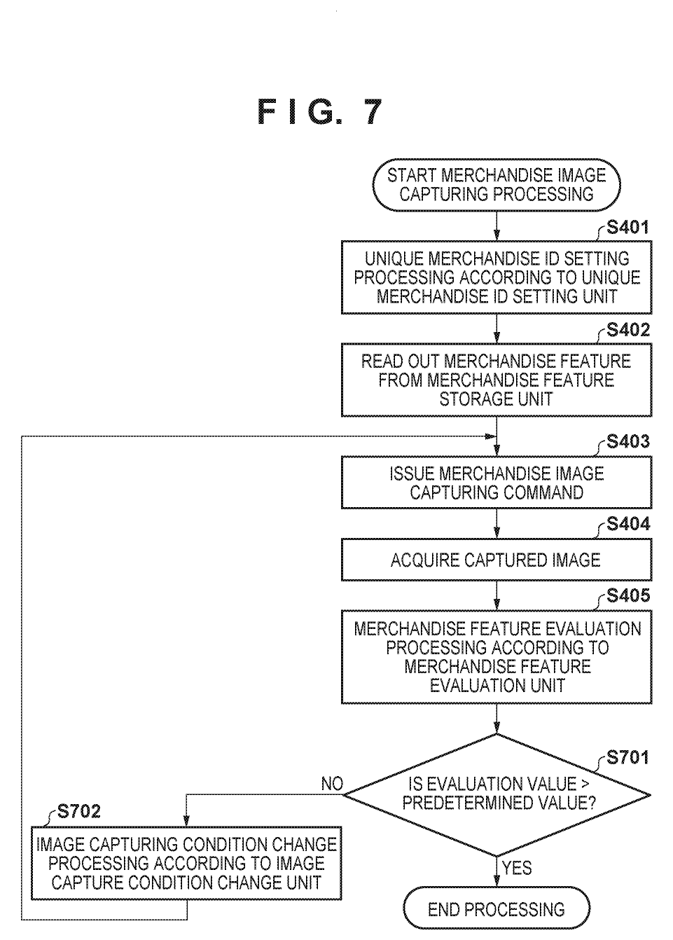

FIG. 7 is a flowchart showing processing of reuse merchandise image capturing and merchandise feature evaluation by the information processing apparatus 101 in the second embodiment. Note that S indicates a step number.

For S401 to S405, processing similar to that of the first embodiment is performed.

In S701, the CPU 205 determines whether or not the evaluation value (score indicating the degree to which the merchandise feature is represented in the captured image) inferred using the merchandise feature evaluation unit 202 is a predetermined value or more. In the embodiment, the predetermined value = 0.8, and if the evaluation value is larger than 0.8, the determination is YES, and the merchandise image capturing processing is ended.

On the other hand, in a case where the evaluation value is 0.8 or less, the processing proceeds to S702.

In S702, the CPU 205 performs image capturing condition change processing by the image capturing condition change unit 601. More specifically, an image capturing condition change instruction is sent to the image capturing apparatus 102 via a communication line.

In the embodiment, a change instruction for an exposure correction value is sent on the assumption that the merchandise feature is not sufficiently represented in a photograph due to blocked up shadows, blown–out highlights, or the like. Image capturing is automatically repeated until the evaluation value by the merchandise feature evaluation unit 202 exceeds the predetermined value.

According to the information processing apparatus 101 of the embodiment, since automatic image capturing is repeated until a high-quality merchandise photograph is obtained while changing image capturing conditions without bothering the user, even a photographer unfamiliar with merchandise image capturing can obtain a high quality merchandise image without trouble.

### Third Embodiment

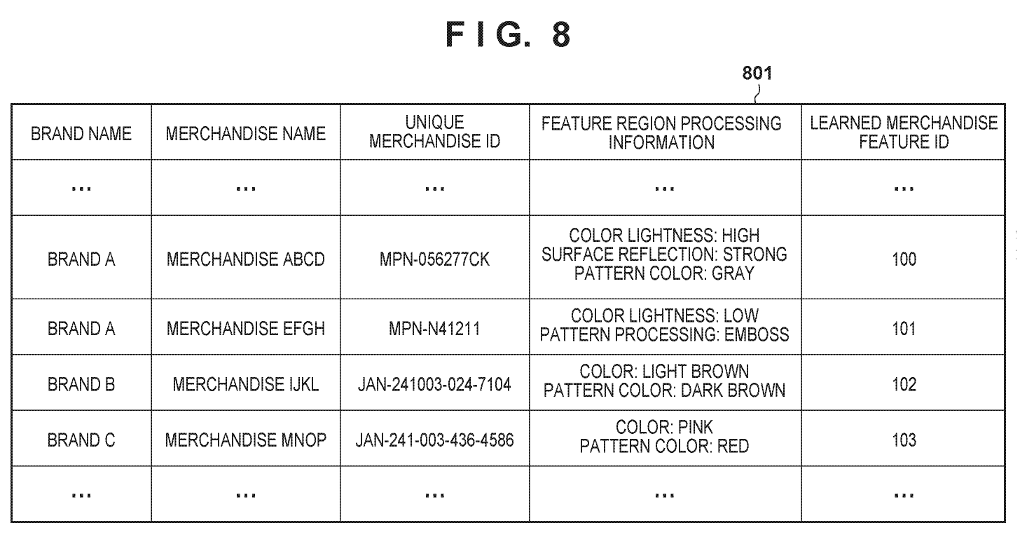

FIG. 8 is a view illustrating information stored in the merchandise feature storage unit 203 in the third embodiment.

As illustrated in FIG. 8, in the third embodiment, feature region processing information is stored. The feature region processing information is information regarding a processing state when a portion of a feature region in the merchandise is manufactured. The content of the feature region processing information includes information such as "color lightness" of the feature region, "degree of reflection" of a surface of the feature region, "color" of a pattern, and "embossing" as a pattern processing method. In the embodiment, it is possible to change an appropriate image capturing condition for performing higher quality image capturing in accordance with the feature region processing information.

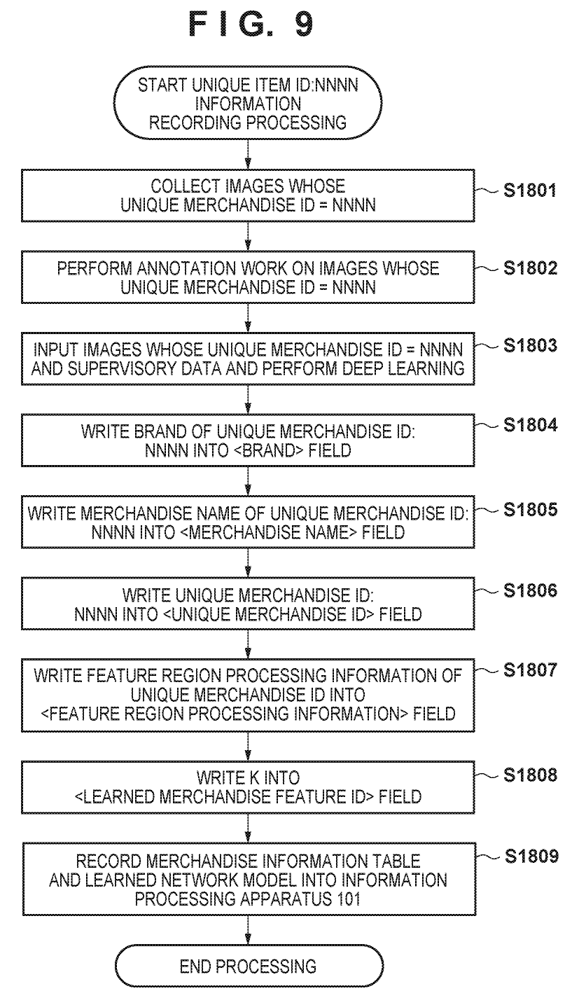

FIG. 9 is a view showing a work flow when a person who intends to build the system of the embodiment generates and records, into the merchandise feature storage unit 203 of the information processing apparatus 101, merchandise feature data of a unique merchandise ID = NNNN. S indicates a step number.

In S1801, the person who intends to build the system collects merchandise images of the unique merchandise ID = NNNN. While the number of images to be collected is as large as possible, the embodiment assumes about 100 images.

In S1802, the person who intends to build the system creates supervisory data of the collected images. More specifically, a characteristic region of the merchandise of the unique merchandise ID = NNNN is defined, and for all of the collected images, this region is surrounded by a frame using an annotation tool or the like, and this region is further tagged as ID = K.

In S1803, the person who intends to build the system causes a learning machine to perform deep learning with the images collected in S1801 and the supervisory data created in S1802 as input.

Note that the learning machine not illustrated may be the information processing apparatus 101. However, similarly to a normal system building flow, in one embodiment, learning is performed at a learning workstation having more powerful GPGU power owned by the system builder and transfer the learning result to the information processing apparatus 101. This enables the information processing apparatus 101 to perform inference such as object detection with high accuracy.

In S1804, the person who intends to build the system writes the brand name of the unique merchandise ID = NNNN into a <Brand> field of a merchandise information table 801 via an input means such as a keyboard.

In S1805, the person who intends to build the system writes the merchandise name of the unique merchandise ID = NNNN into a <Merchandise Name> field of the merchandise information table 801 via an input means such as a keyboard.

In S1806, the person who intends to build the system writes the unique merchandise ID = NNNN into a <Unique Merchandise ID> field of the merchandise information table 801 via an input means such as a keyboard.

In S1807, the person who intends to build the system writes the processing information on the feature region of the unique merchandise ID = NNNN into a <Feature Region Processing Information> field of the merchandise information table 801 via an input means such as a keyboard.

In S1808, the person who intends to build the system writes K, which is an ID tagged at the time of learning, into a <Learned Merchandise Feature ID> field of the merchandise information table 801 via an input means such as a keyboard.

In S1809, the person who intends to build the system records, into the information processing apparatus 101, the merchandise information table 801 and the learned model generated in S1803, and ends the processing.

Note that the processing flow shown in FIG. 9 shows the information recording processing of one unique item of merchandise. However, in one embodiment, the processing shown in FIG. 9 is performed on all items of unique merchandise targeted by the reuse merchandise image capturing system, and write, into the information processing apparatus 101, the merchandise information table 801 and the learned model obtained as a result thereof. Then, when handling new merchandise, in one embodiment, additionally record information is recorded on the new merchandise into the merchandise information table 801 and cause a learning model to perform additional learning.

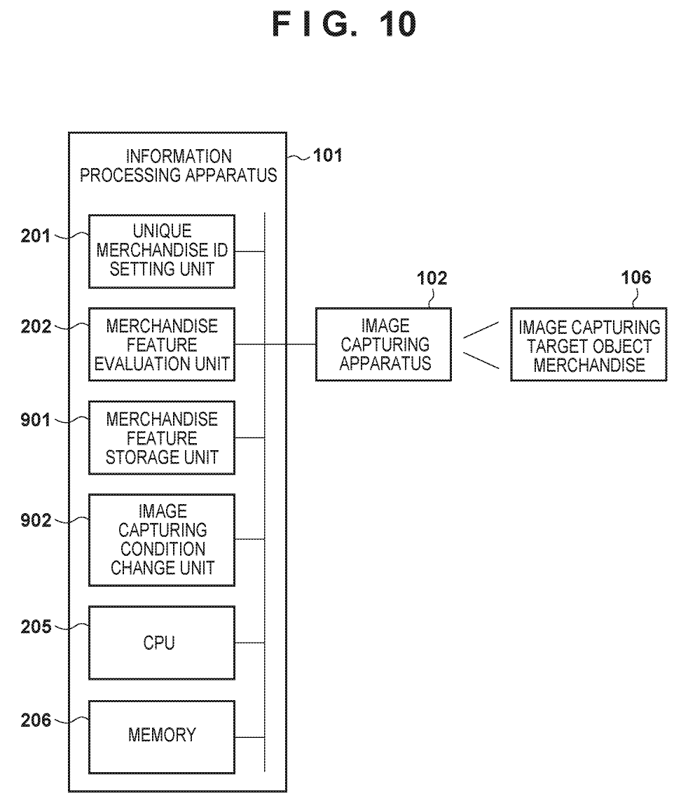

FIG. 10 is a view illustrating the configuration of the reuse merchandise image capturing system of the third embodiment.

In the third embodiment, a merchandise feature storage unit 901 stores the information illustrated in FIG. 8. An image capturing condition change unit 902 changes an image capturing condition in accordance with the feature region processing information illustrated in FIG. 8.

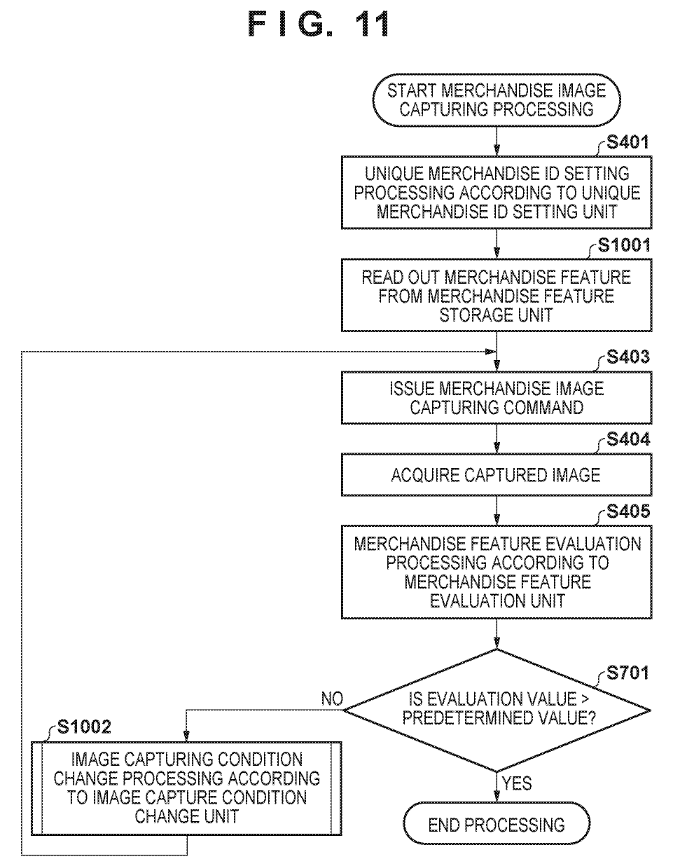

FIG. 11 is a flowchart showing processing of reuse merchandise image capturing and merchandise feature evaluation by the information processing apparatus 101 in the third embodiment. Note that S indicates a step number.

In S401, S403, S404, and S405, processing similar to that of the first embodiment is performed.

In S701, processing similar to that of the second embodiment is performed.

In S1001, the CPU 205 reads merchandise feature information from the merchandise feature storage unit 901. In the embodiment, the feature region processing information of the table 801 is also read.

In S1002, after the CPU 205 performs processing for changing an image capturing condition considered to be appropriate from the read feature region processing information, the processing proceeds to S403 again.

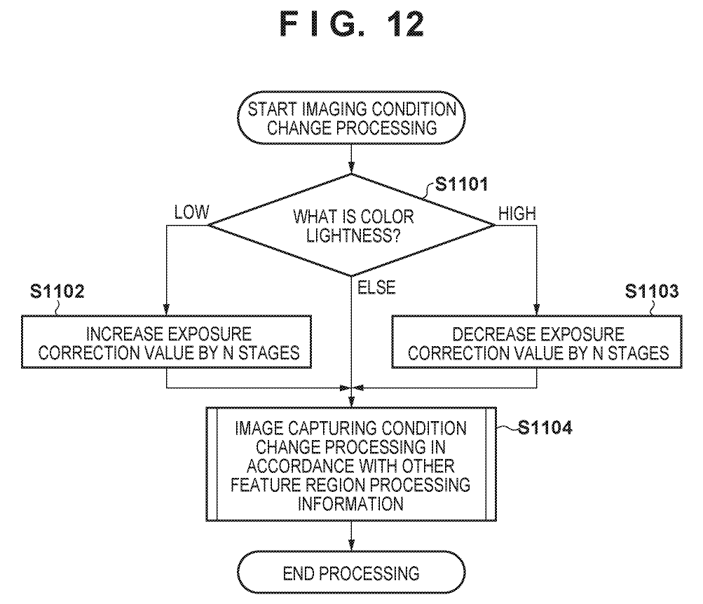

FIG. 12 is a flowchart showing the processing for changing the image capturing condition in S1002.

In S1101, the CPU 205 reads information corresponding to "color lightness" from the feature region processing information, and determines whether it is "lower" or "higher" than a predetermined lightness, or neither of those.

In a case where this determination is "low", there is a possibility that the feature is not represented because the characteristic region has blocked up shadows. Therefore, as change content of the image capturing condition, after the processing of increasing the exposure correction value by N stages is performed in S1102, the processing proceeds to S1104.

In a case where this determination is "high", there is a possibility that the feature is not represented because the characteristic region is blown out. Therefore, as change content of the image capturing condition, after the processing of decreasing the exposure correction value by N stages is performed in S1103, the processing proceeds to S1104.

Here, the value of N may be appropriately determined based on the properties of image capturing equipment, knowledge at the image capturing site, and the like.

In a case where this determination is neither "low" nor "high", it is determined that there is no particular need to correct the exposure correction value, and the processing proceeds to S1104.

Note that in the embodiment, exposure correction has been described as an example of means for improving blocked up shadows and blown–out highlights. However, the disclosure is not limited to this. For example, in the process of development processing performed on raw data of an image capturing element, processing may be performed such as tone curve correction for giving more gradation to dark portions performed for blocked up shadows, and tone curve correction for giving more gradation to a place with high lightness performed in a case of blown–out highlights. That is, another image capturing condition for giving richer gradation to lightness in which gradation is insufficient to represent the feature may be changed.

In S1104, with reference to the feature region processing information, the CPU 205 performs change processing on another image capturing condition as necessary, and then ends the processing of the present flow.

According to the information processing apparatus 101 of the embodiment, similarly to the second embodiment, automatic image capturing is repeated until a high quality merchandise photograph is obtained while changing image capturing conditions without bothering the user. Therefore, even a photographer unfamiliar with merchandise image capturing can obtain a high quality merchandise photograph without trouble. By referring to processing information on the feature region, a high quality image capturing result can be accurately obtained in less time, and the work time of the user can be greatly shortened.

### Fourth Embodiment

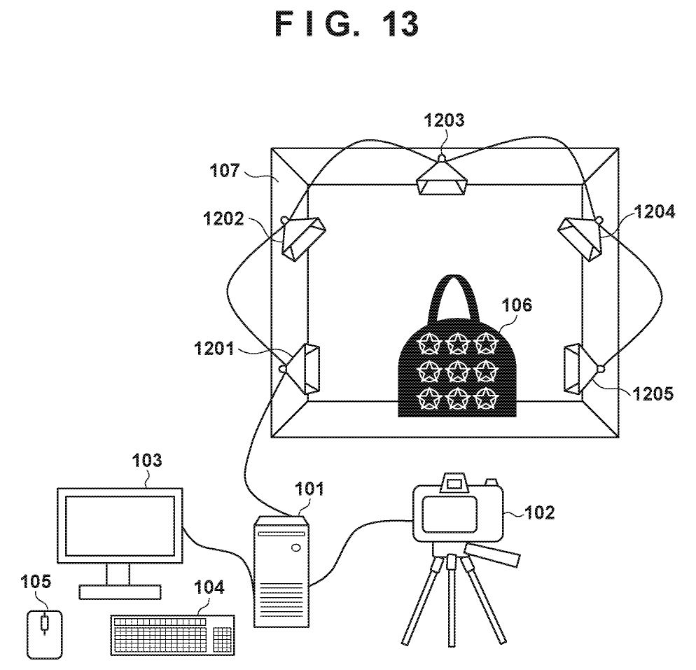

FIG. 13 is a view illustrating the appearance of the reuse merchandise image capturing system of the fourth embodiment.

In FIG. 13, illumination apparatuses 1201 to 1205 are connected to the information processing apparatus 101 in a communication-enabling manner, and can set brightness and the like for each illumination apparatus. Note that the illumination apparatus may emit light at the moment of image capturing such as a strobe, or may continue to shine for a long period of time such as illumination for image capturing a moving image.

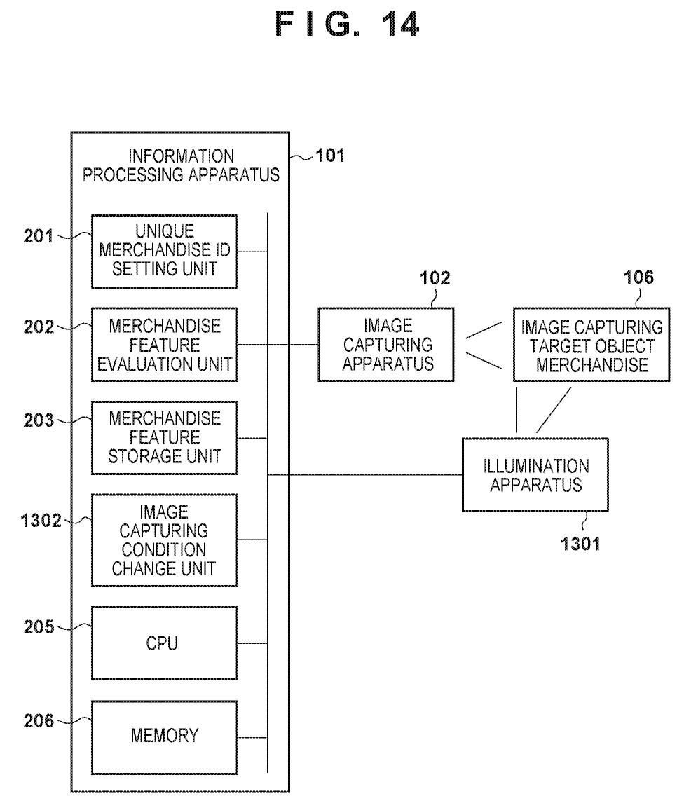

FIG. 14 is a view illustrating the configuration of the reuse merchandise image capturing system of the fourth embodiment. In FIG. 14, an illumination apparatus 1301 corresponds to the illumination apparatuses 1201 to 1205 in the external view of FIG. 13.

In FIG. 14, an image capturing condition change unit 1302 performs a similar operation to that in the first to third embodiments and individually controls the brightness of each of the illumination apparatuses 1201 to 1205.

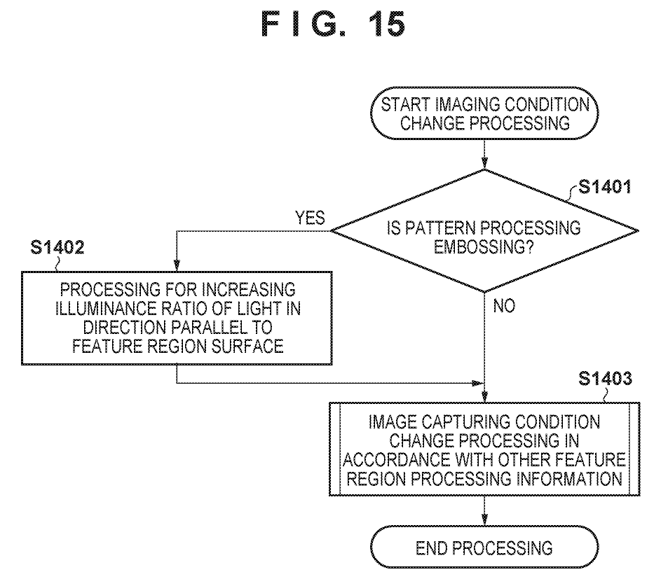

The flowchart of processing of reuse merchandise image capturing and merchandise feature evaluation in the fourth embodiment is similar to that in the third embodiment of FIG. 11. FIG. 15 is a flowchart describing the image capturing condition change processing of S1002 in the fourth embodiment.

In S1401, the CPU 205 reads information corresponding to "pattern processing" from the feature region processing information, and determines whether it is "embossing" or not.

In a case where this determination is "embossing", it is determined that the current illumination situation is illumination in which the shade of embossing of the characteristic region is not represented, and the processing proceeds to S1402. In a case where this determination is not embossing, the processing proceeds to S1403.

In S1402, as an image capturing condition for representing the shade of embossing, the illumination apparatus 1301 is controlled so as to increase the illuminance ratio of illumination in which light is irradiated in a direction parallel to a feature region surface, and then the processing proceeds to S1403.

As a merchandise image capturing technique, in order to make embossing of an embossed surface conspicuous, it is necessary to enhance not illumination to be irradiated in a direction perpendicular to the embossed surface but illumination to be irradiated in a direction parallel to the embossed surface. In S1402, processing similar to this technique is performed by controlling the plurality of illuminations 1201 to 1205.

By controlling a ratio change in brightness in the irradiation direction of the illumination, it is possible to not only make the embossing of the merchandise feature region conspicuous but also make the unevenness (texture) of the skin of a leather product conspicuous to improve the quality of merchandise image capturing.

In S1403, with reference to the feature region processing information, the CPU 205 performs change processing on another image capturing condition as necessary, and then ends the processing of the present flow.

According to the information processing apparatus 101 of the embodiment, similarly to the second embodiment, automatic image capturing is repeated until a high quality merchandise photograph is obtained while changing image capturing conditions including illumination conditions without bothering the user. Therefore, even a photographer unfamiliar with merchandise image capturing can obtain a high quality merchandise photograph without trouble. By referring to processing information on the feature region, a high quality image capturing result can be accurately obtained in less time, and the work time of the user can be greatly shortened.

### Fifth Embodiment

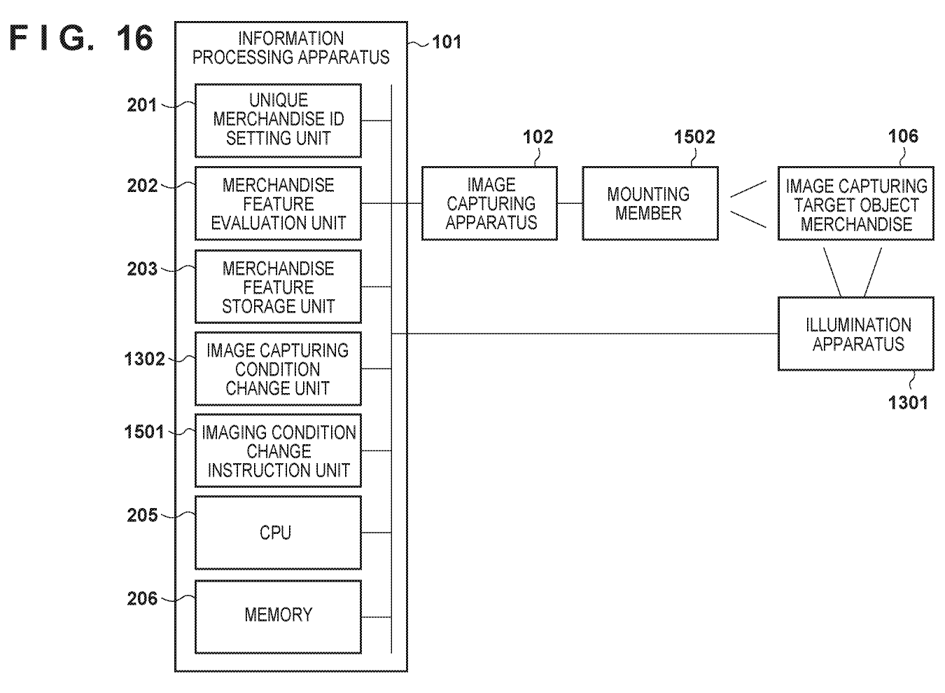

FIG. 16 is a view illustrating the configuration of the reuse merchandise image capturing system of the fifth embodiment.

In FIG. 16, an image capturing condition change instruction unit 1501 prompts the user for a change instruction regarding an image capturing condition in which the system cannot automatically change the setting.

In the embodiment, the image capturing condition change instruction unit 1501 displays, on the display 103, a message prompting the user to mount a polarizing filter as a mounting member 1502 to be mounted to the camera. However, the change instruction is not limited to this, and a user instruction may be issued by voice. Other instruction means and instruction content may be adopted as long as it instructs the user to change the image capturing condition that cannot be automatically set by the system, such as mounting of an ND filter or a filter mounted to an illumination, other than the polarizing filter.

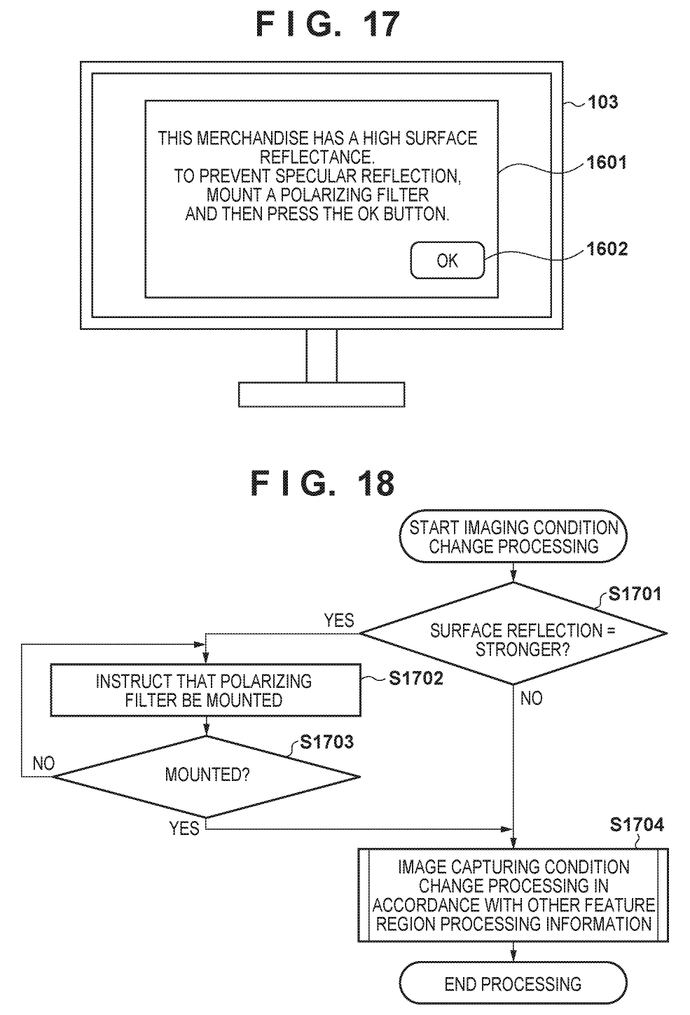

FIG. 17 is a view illustrating instructing the user to change an image capturing condition, and an instruction message 1601 for mounting a polarizing filter is displayed on the display 103. When an OK button 1602 is input by an input means such as the mouse 105, the image capturing system determines that the change of the image capturing condition has been completed by the user and performs re-imaging.

FIG. 18 is a flowchart describing the image capturing condition change processing in the fifth embodiment in more detail.

In S1701, the CPU 205 reads information corresponding to "surface reflection" from the feature region processing information, and determines whether it is "stronger" than a predetermined value or not. In a case where this determination is other than "stronger", the processing proceeds to S1704. In a case where this determination is "stronger", the processing proceeds to S1702.

In S1702, the CPU 205 issues a message instructing the user to mount the polarizing filter. In the embodiment, a message as indicated in 1601 of FIG. 17 is displayed.

In S1703, the CPU 205 determines whether or not the mounting of the polarizing filter is completed. Until the user presses the OK button 1602, the determination is NO with the mounting being incomplete, and the process returns to S1702. When the user presses the OK button 1602, the determination in S1703 is YES, and the processing proceeds to S1704.

In S1704, with reference to the feature region processing information, the CPU 205 performs change processing on another image capturing condition as necessary, and then ends the processing of the present flow.

According to the information processing apparatus 101 of the embodiment, even in a case of change of an image capturing condition that cannot be automatically changed by the system, even a user unfamiliar with image capturing can obtain a high quality image capturing result by an instruction for image capturing condition change content to the user.

### Other Embodiments

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025- 011656, filed January 27, 2025, which is hereby incorporated by reference herein in its entirety.

What is claimed is:

1. A processing apparatus comprising:
at least one processor and at least one memory storing instructions to cause the at least one processor to function as:
a setting unit that sets an ID unique to article that is a target object;
a storage unit that stores a feature of article for the ID;
a first acquisition unit that acquires a feature of the article corresponding to the ID from the storage unit;
a second acquisition unit that acquires an image in which the article is imaged; and
an evaluation unit that evaluates whether a feature of the article is represented in the image.

2. The processing apparatus according to claim 1 further comprising an output unit that outputs an instruction for re-imaging the article based on an evaluation result by the evaluation unit.

3. The processing apparatus according to claim 2, wherein the output unit outputs an instruction for causing a display device to display a display prompting re-imaging of the article.

4. The processing apparatus according to claim 2, wherein the output unit outputs an instruction for re-imaging the article in a case where the evaluation result is lower than a predetermined value.

5. The processing apparatus according to claim 2, wherein the output unit outputs an instruction for changing a setting for image capturing the article to performing re-imaging.

6. The processing apparatus according to claim 5, wherein the storage unit stores processing information on a feature region of the article, and the output unit outputs an instruction to change a setting for image capturing the article based on the processing information.

7. The processing apparatus according to claim 6, wherein in a case where lightness of a color of the feature region is lower than a predetermined value in the processing information, the output unit outputs an instruction to increase an exposure correction value of an image capturing apparatus that images the article as a change of a setting for image capturing the article.

8. The processing apparatus according to claim 6, wherein in a case where lightness of a color of the feature region is higher than a predetermined value in the processing information, the output unit outputs an instruction to decrease an exposure correction value of an image capturing apparatus that images the article as a change of a setting for image capturing the article.

9. The processing apparatus according to claim 6, wherein in a case where the feature region is embossed in the processing information, the output unit outputs an instruction to increase a ratio of brightness in a direction parallel to a surface of the feature region to an illumination apparatus that illuminates the article.

10. The processing apparatus according to claim 6, wherein in a case where an instruction to change a setting for image capturing the article is an instruction for a setting change that cannot be automatically changed by an image capturing apparatus that images the article, the output unit outputs an instruction to prompt a user to change a setting of image capturing.

11. The processing apparatus according to claim 10, wherein in a case where surface reflection of the feature region is stronger than a predetermined value in the processing information, an instruction to mount a polarizing filter to an image capturing apparatus that images the article is output to a user.

12. A method for a processing apparatus including a setting unit that sets an ID unique to article of an image capturing target object, and a storage unit that stores a feature of article for the ID, the method comprising:
acquiring a feature of the article corresponding to the ID from the storage unit;
acquiring an image in which the article is imaged; and
evaluating whether a feature of the article is represented in the image.

13. The method according to claim 12 further comprising outputting an instruction for re-imaging the article based on an evaluation result by the evaluating.

14. The method according to claim 13, wherein the outputting outputs an instruction for causing a display device to display a display prompting re-imaging of the article.

15. The method according to claim 13, wherein the outputting outputs an instruction for re-imaging the article in a case where the evaluation result is lower than a predetermined value or for changing a setting for image capturing the article to performing re-imaging.

16. A non-transitory computer-readable storage medium storing a program for causing a computer to execute a method for a processing apparatus including a setting unit that sets an ID unique to article of an image capturing target object, and a storage unit that stores a feature of article for the ID, the method comprising:
acquiring a feature of the article corresponding to the ID from the storage unit;
acquiring an image in which the article is imaged; and
evaluating whether a feature of the article is represented in the image.

17. The non-transitory computer-readable storage medium according to claim 16 further comprising outputting an instruction for re-imaging the article based on an evaluation result by the evaluating.

18. The non-transitory computer-readable storage medium according to claim 17, wherein the outputting outputs an instruction for causing a display device to display a display prompting re-imaging of the article.

19. The non-transitory computer-readable storage medium according to claim 17, wherein the outputting outputs an instruction for re-imaging the article in a case where the evaluation result is lower than a predetermined value or for changing a setting for image capturing the article to performing re-imaging.
